(19) United States
(12) Patent Application Publication
(10) Pub. No.: US 2009/0296072 A1
(43) Pub. Date: Dec. 3, 2009

(54) Measuring apparatus

(76) Inventor: Dong-Hun Kang, Busan (KR)

Correspondence Address: WENDEROTH, LIND & PONACK, L.L.P., 1030 15th Street, N.W.,, Suite 400 East, Washington, DC, 20005-1503, US

(21) Appl. No.: 11/792,842

(22) PCT Filed: Dec. 18, 2006
(86) PCT No.: PCT/KR2006/005531

§ 371 Date: Jun. 12, 2007

(30) Foreign Application Priority Data
Jan. 4, 2006 (KR) 1020060000945

(51) Int. Cl. G01C 3/02; G01C 3/00

(52) U.S. Cl. 356/18; 33/277

(57) ABSTRACT

A measuring apparatus is conveniently used without a support such as a tripod, and simply measures a relative distance between two arbitrary points, i.e. two arbitrary measurement target objects, without restriction as to the positions of the measurement target objects. Further, the measuring apparatus realizes a very simple measurement process, so that a user can have faith in the measured distance. The measuring apparatus allows first and second indicators to be easily oriented towards the two points that the user wants to measure using the manipulation of the first and second indicators.

### TECHNICAL FIELD

The present invention relates, in general, to a measuring apparatus for measuring the relative distance between two different points.

### BACKGROUND ART

In general, an ultrasonic distance meter using an electronic device, a distance meter using reflected waves of a laser, etc. have been commercialized, and are used to measure a distance with precision.

Among them, the ultrasonic distance meter is based on an electromagnetic induction phenomenon or a piezoelectric phenomenon, and generally includes an emitter and a receiver. When the emitter emits ultrasonic waves, the receiver receives the ultrasonic waves, which hit and are reflected back from a measurement target object. At this time, the distance to the measurement target object can be calculated from the speed and the time between transmission and reception of the ultrasonic waves. The time between transmission and reception can be measured using a flip-flop as follows. This flip-flop is set when the emitter emits the ultrasonic waves, and is reset when the receiver detects the ultrasonic waves. A pulse, the width of which corresponds to the time that it takes the ultrasonic waves to be reflected back, is produced, and thereby the time can be obtained through this pulse.

The laser distance meter is based on a method of using phase variation of reflected light waves, a method of using a pulse, a method of receiving reflected light waves using trigonometry, and so on. In the method of using a pulse, which has been generally used, a single pulse or a series of pulses, either of which is coherent light, are radiated towards a measurement target object. Here, although the light propagates a distance of several kilometers, it is hardly scattered at all, so that the pulse (or light) has a diameter of no more than about 1 meter. When the light arrives at the measurement target object, it scatters in every direction. However, some of the light energy is reflected back to and detected by the laser distance meter. The laser distance meter measures the time that it takes the pulse to be reflected back, thereby determining the distance to the measurement target object.

This conventional method can be expressed as in FIG. 1. Here, the distance between the meter and the measurement target object is called the “direct distance.” This measurement method is called the “direct distance measurement method,” and apparatuses capable of measuring the direct distance are called “distance measurement modules.”

Meanwhile, the conventional method of measuring the distance between two different points basically uses the distance measurement module capable of calculating the direct distance (on the basis of the laser or the ultrasonic waves), as illustrated in FIG. 2, wherein the distance measurement module is rotatably fixed to a support such as a tripod.

When the relative distance L between two different points A and B is be measured, the meter is first installed at an arbitrary point.

The meter measures the distance L1 to the point A, and then the measured distance L1 is stored in the memory of the meter. When the measurement of L1 is completed, the meter is rotated toward the point B by θ (here, θ refers to the angle between the points A and B). Then, the meter measures the distance L2 to the point B, and the measured distance L2 and the angle θ are stored in the memory. The relative distance L between the points A and B is calculated using trigonometry.

This conventional method of measuring the relative distance has the following problems.

(1) Because the meter itself must be rotatably fixed to the tripod, it's the volume and weight thereof are increased, and thus is not suitable for mobile use.

(2) If the measurement target objects A and B are located at different heights, the meter must be adapted to rotate about two axes on the tripod in order to measure them, and be provided with a rotation angle sensing means capable of detecting the rotation angles.

In other words, if the measurement target objects A and B are located at the same height, the meter has only to be adapted to rotate along the plane parallel to the ground, and to have a sensing means capable of detecting the horizontal rotation angle. However, if the measurement target objects A and B are located at different heights, the meter must be adapted not only to rotate along the plane parallel to the ground but also to pivot in upward and downward directions, and to be provided with a sensor capable of detecting the horizontal and vertical rotation angles.

(3) Due to the measurement method (2) of measuring the direct distances L1 and L2, the measurement method is complicated and takes a long time. For this reason, the user doubts the exact position of the previous measurement point, that is, the measurement target object A, when measuring the distance L2 to the measurement target object B, so that the reliability of the calculated relative distance L is lowered.

### DISCLOSURE

### Technical Problem

Accordingly, the present invention has been made in an effort to solve the problems occurring in the related art, and an object of the present invention is to provide a measuring apparatus, which can be conveniently used without a support such as a tripod, makes it simple to measure the relative distance between two arbitrary points, i.e. two arbitrary measurement target objects, without restriction as to the positions of the measurement target objects, provides a user with a reliably measured distance because the measurement process is very simple, and causes first and second indicators to be intuitively oriented to the two points that the user wants to measure by the manipulation of the first and second indicators.

### Technical Solution

In order to achieve the above object, according to one aspect of the present invention, there is provided a measuring apparatus for measuring the relative distance between two different points. The measuring apparatus comprises: a first body having a first indicator for indicating a first direction; a second body having a second indicator for indicating a second direction and rotating relative to the first body; a first distance measurement module fixed to the first indicator in the first direction, indicated by the first indicator; a second distance measurement module fixed to the second indicator in the second direction indicated by the second indicator; a rotation angle sensing means detecting the rotation angle between the first and second indicators; a controller receiving the rotation angle detected by the rotation angle sensing means, the direct distance to the first point measured by the first distance measurement module, and the direct distance to the second point measured by the second distance measurement module, and calculating the relative distance; and a display displaying the relative distance calculated by the controller.

### ADVANTAGEOUS EFFECTS

According to the present invention, the measuring apparatus can be conveniently used without a support such as a tripod, and can simply measure the relative distance between two arbitrary points, i.e. two measurement target objects, without any limitation with respect to the positions of the measurement target objects. Further, the measuring apparatus provides a user with a reliable measured distance because the measurement process is very simple. In addition, the measuring apparatus employs the first and second indicators, which have the shape of bars long enough to clearly indicate a direction to be indicated, and thereby the first and second indicators are unfolded toward the measurement target objects, so that the distance can be measured in a rapid and simple manner.

### DESCRIPTION OF DRAWINGS

FIG. 1 illustrates a conventional method for direct distance measurement;

FIG. 2 illustrates a conventional method for relative distance measurement;

FIG. 3 is a schematic perspective view illustrating the appearance of a portable measuring apparatus according to an exemplary embodiment of the present invention;

FIG. 4 is a schematic perspective view illustrating the portable measuring apparatus of FIG. 3 when unfolded;

FIG. 5 is a schematic perspective view illustrating the portable measuring apparatus of FIG. 3 when disassembled;

FIG. 6 is a block diagram showing control of the portable measuring apparatus of FIG. 3;

FIG. 7 illustrates how to use the portable measuring apparatus of FIG. 3; and

FIGS. 8 and 9 are conceptual views for explaining a method of calculating a distance and a method of indicating a middle point using the portable measuring apparatus of FIG. 3, respectively.

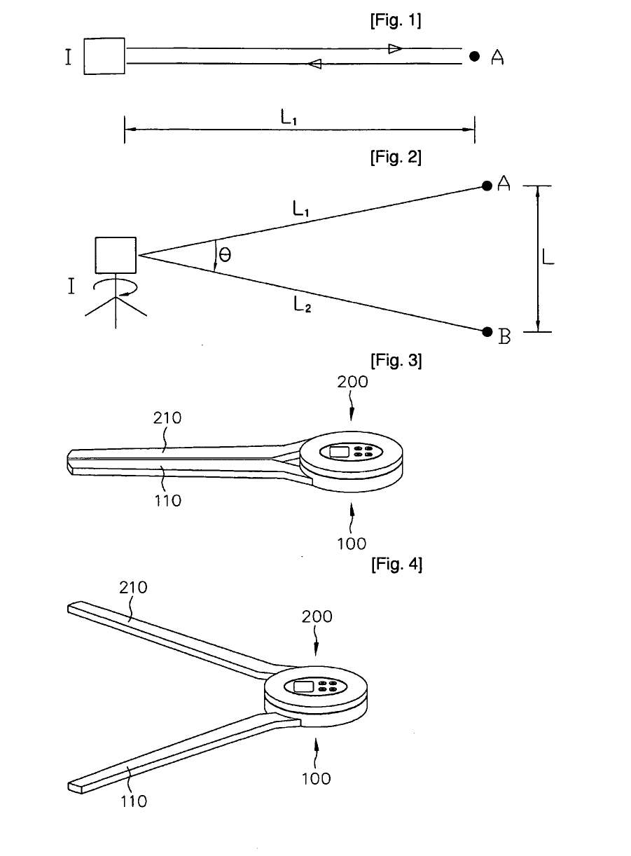

### BEST MODEL

Reference will now be made in greater detail to an exemplary embodiment of the invention, an example of which is illustrated in the accompanying drawings.

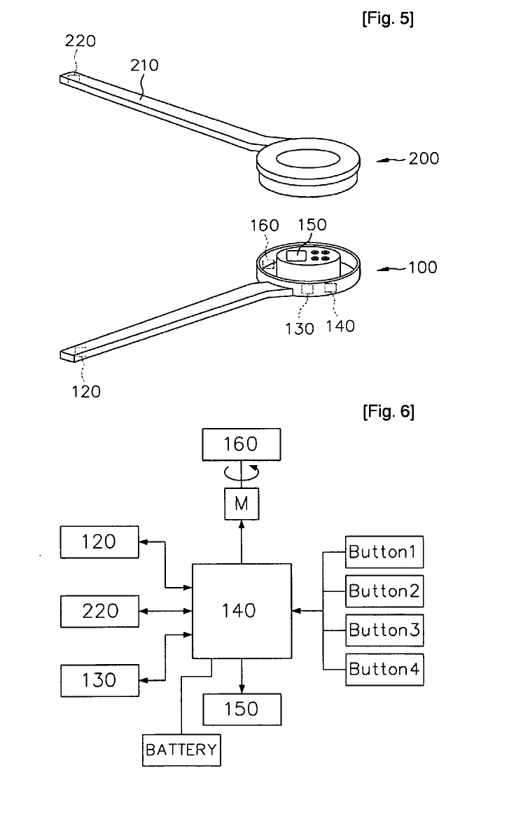

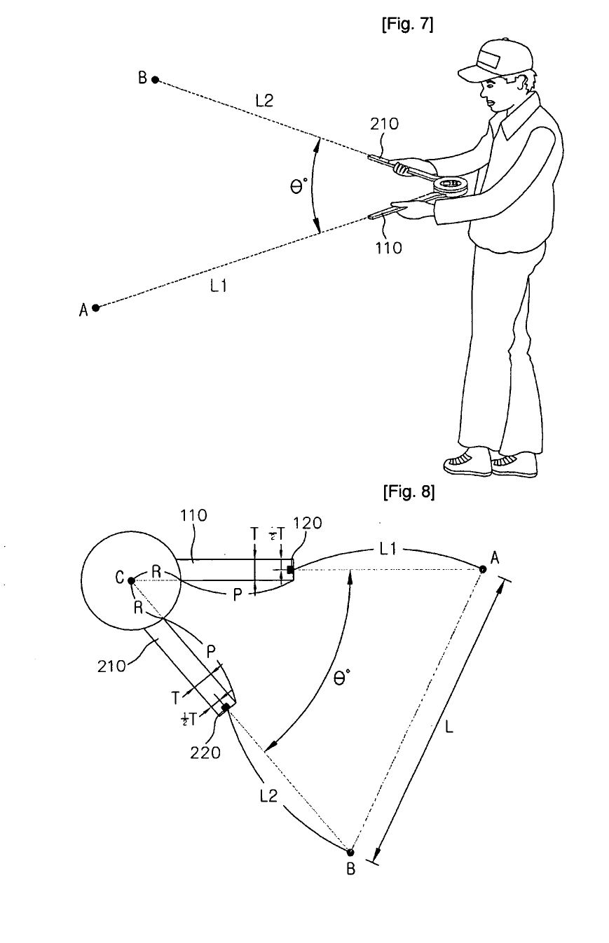

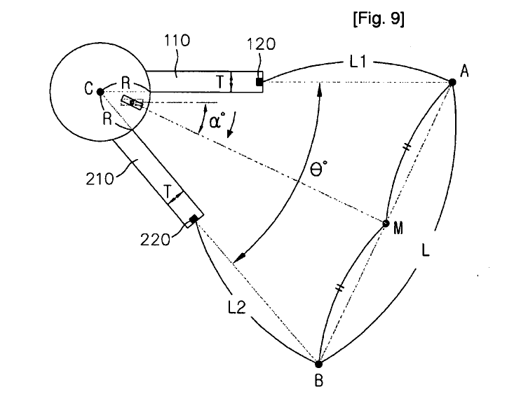

FIG. 3 is a schematic perspective view illustrating the appearance of a portable measuring apparatus according to an exemplary embodiment of the present invention. FIG. 4 is a schematic perspective view illustrating the portable measuring apparatus of FIG. 3 when unfolded. FIG. 5 is a schematic perspective view illustrating the portable measuring apparatus of FIG. 3 when disassembled. FIG. 6 is a block diagram showing the control of the portable measuring apparatus of FIG. 3. FIG. 7 illustrates how to use the portable measuring apparatus of FIG. 3. FIGS. 8 and 9 are conceptual views for explaining a method of calculating a distance and a method of indicating a middle point, respectively, using the portable measuring apparatus of FIG. 3.

The portable measuring apparatus generally includes a first body 100 and a second body 200, which are assembled so as to rotate relative to each other. Thus, the first and second bodies 100 and 200 are folded for storage when not in use, as in FIG. 3, but they are unfolded when being used, as in FIG. 4. This assembled structure is a typical structure, and so a detailed illustration and description thereof will be omitted.

The first body 100 is provided with a first indicator 110 having the shape of a bar long enough to make it easy to perceive an indicating direction. The first indicator 110 is provided therein with a first distance measurement module 120, which is disposed in the direction indicated by the first indicator 110.

Further, the second body 200 is provided with a second indicator 210 having the shape of a bar that is long enough to make it easy to perceive an indicating direction. The second indicator 210 is provided therein with a second distance measurement module 220, which is disposed in the direction indicated by the second indicator 210.

The first and second distance measurement modules 120 and 220 refer to a measuring device that is capable of measuring the direct distance to a measurement target point, and are well known in the art. Herein, the first and second distance measurement modules 120 and 220, preferably, are laser-based distance measurement modules, and thus the measurement target point, which is the measurement target object, can be visually checked. In the case in which the measurement module is based on ultrasonic waves, a separate laser beam for checking the measurement target point must be radiated, or an equivalent medium, also capable of checking the measurement target point, must be provided therewith.

Further, the expression “the shape of a bar long enough to make it easy to perceive an indicating direction” means that a ratio of width to length must be enough to indicate a concrete direction, like a ballpoint pen or a pencil.

Therefore, a user grasps the first and second indicators 110 and 210 of the first and second bodies 100 and 200, and then unfolds them toward desired measurement target points. Thereby, the user intuitively enables the directions, indicated by the first and second indicators 110 and 210, and orients them towards the measurement target points with no difficulty.

Meanwhile, the first body 100 is provided with a rotation angle sensing means 130 for detecting the rotation angle between the first and second indicators 110 and 120, which are unfolded, so that the rotation angle between the first and second indicators 110 and 120 can be detected when the first and second indicators 110 and 120 are unfolded. The rotation angle sensing means 130 is widely used in an existing laser measuring apparatus, and thus a detailed illustration and description will be omitted.

Further, the first body 100 is provided with a display 150 (e.g. a liquid crystal display (LCD), a light emitting diode (LED) display, etc.) for visually displaying the measured distance. Alternatively, the display 150 may include a device capable of aurally expressing the distance.

The portable measuring apparatus includes a plurality of operating buttons around the display 150. These buttons include an on/off button, a relative distance measurement button, a middle point display button, a direct distance measurement button, and so on.

Further, the first body 100 is provided with a controller 140. The controller 140 is connected to the first distance measurement module 120, the second distance measurement module 220, and the rotation angle sensing means 130, thereby controlling the operation of the connected parts. The controller 140 calculates the distance, and sends data about the calculated direct or relative distance to the display 150, so as to enable the user to see or hear the data.

In addition, the first body 100 is provided with a laser beam generator 160 for displaying the middle point. The laser beam generator 160 is rotated by a driving motor (not shown). The rotation of the driving motor is controlled by the controller 140.

Hereinafter, a process of calculating the relative distance L will be described with reference to FIGS. 7 and 8.

First, the user grasps and unfolds the first and second indicators 110 and 210 of the portable measuring apparatus. Thereby, the first and second distance measurement modules 120 and 220 are oriented towards the points A and B, respectively. Preferably, the positions towards which the distance measurement modules are oriented are visually indicated on the measurement target points for the purpose of precise measurement. Hence, each distance measurement module itself is preferably based on a laser rather than on ultrasonic waves.

When the first and second distance measurement modules 120 and 220 are oriented to the points A and B respectively, the user pushes the relative distance measurement button of the portable measuring apparatus.

Thereby, the first distance measurement module 120 measures the direct distance L1 to the point A, and the second distance measurement module 220 measures the direct distance L2 to the point B. The rotation angle sensing means 130 detects the rotation angle θ between the first indicator 110 and the second indicator 210.

The controller 140 calculates the relative distance L between the points A and B using L1, L2 and θ, and the display 150 displays the calculated result visually or aurally.

The method of calculating the relative distance L is illustrated in FIG. 8.

First, parts serving as invariable constants will be described.

In the present invention, the first indicator 110 and the second indicator 210 are in contact with each other. Thus, interfaces of the first and second indicator 110 and 210, in contact with each other, extend to pass through the fixed center C. Further, the first and second distance measurement modules 120 and 220 are fixed at arbitrary positions on the first and second indicator 110 and 210, respectively. Thus, R, P and T serve as constants in FIG. 8,

Here, it is assumed that the first and second distance measurement modules 120 and 220 are installed at free ends and intermediate points, preferably middle points, of widths T of the first and second indicator 110 and 210, respectively.

Meanwhile, the direct distances L1 and L2 and the rotation angle θ, which are measured, vary depending on the measurement target points, and thus serving as variables.

In this case, the relative distance L can be expressed using the following trigonometric function:

L=f(L1, L2, θ, R, P, T)

The method of calculating L in this manner is only an example, and thus can be variously modified or changed within the spirit and scope of the prevent invention by a person having ordinary skill in the art.

Meanwhile, after the relative distance L is calculated, the user often wants to check where the middle point M between the points A and B is located. In this case, the user pushes the middle point display button, and thereby the controller 140 calculates how the driving motor rotating the laser beam generator 160 for displaying the middle point is to be rotated. According to the calculated result, the controller 140 drives the driving motor to rotate the laser beam generator 160, and thereby the laser beam generator 160 scans the middle point M.

In other words, FIG. 9 illustrates the process in which the laser beam generator 160 rotates by α in order to scan the middle point M according to the rotation of the driving motor after the relative distance L is calculated. Here, α can be also calculated using the trigonometric function.

Specifically, the laser beam generator 160 is located a predetermined distance m from the center C and is oriented at a predetermined angle r. Hence, when the predetermined length m and angle r are defined as constants, α can be defined as a function in terms of the constants R, P and T and the variables L1, L2 and θ for L, and the length m and the angle r for the position of the laser beam generator 160, as follows:

α=f(m, r, L1, L2, θ, R, P, T)

When the direct distance measurement button is pushed, the first or second distance measurement module 120 or 220 operates to measure the direct distance, and then the measured direct distance is displayed on the display 150.

Meanwhile, each of the first and second distance measurement modules 120 and 220 is provided with a transparent window, so that the measurement target points can be marked with a crisscross instead of a point. Thus, when a first crisscross horizontal line marking the measurement target point A is connected with a second crisscross horizontal line marking the measurement target point B, the measurement target points A and B can be expressed by one line. In other words, the crisscross horizontal line marking the measurement target point A can be connected with the crisscross horizontal line marking the measurement target point B, so that the user can check the line connecting the measurement target points A and B.

Further, the laser beam generator 160 is provided with a transparent window marked with a crisscross, and the middle point is marked with a crisscross, for increased perceptibility.

Meanwhile, the size of the portable measuring apparatus can be varied as needed.

Further, the portable measuring apparatus is no hindrance during measurement in the case in which the two points A and B are located vertically or obliquely. In this case, however, if the display 150 visually indicates the distance, the distance displayed on the display 150 must be easy to check, that is, it must be checked from the side of the portable measuring apparatus. To this end, a separate means for varying the position of the display 150 can be provided, or the display 150 can be adapted to have a rotatable structure.

In the drawings and specification, typical exemplary embodiments of the invention have been disclosed, and although specific terms are employed, they are used in a generic and descriptive sense only, and are not for the purposes of limitation, the scope of the invention being as set forth in the following claims.

### INDUSTRIAL APPLICABILITY

The present invention can be widely applied to a portable measuring apparatus for measuring the relative distance between two different points.

1. A measuring apparatus for measuring a relative distance (L) between two different points (A and B), the measuring apparatus comprising:
a first body having a first indicator for indicating a first direction;
a second body having a second indicator for indicating a second direction and rotating relative to the first body;
a first distance measurement module fixed to the first indicator in the first direction, which the first indicator indicates;
a second distance measurement module fixed to the second indicator in the second direction, which the second indicator indicates;
a rotation angle sensing means detecting a rotation angle between the first and second indicators;
a controller receiving the rotation angle detected by the rotation angle sensing means, a direct distance (L1) to the point (A) measured by the first distance measurement module, and a direct distance (L2) to the point (B) measured by the second distance measurement module, and calculating the relative distance (L); and
a display displaying the relative distance (L) calculated by the controller.

2. The measuring apparatus as set forth in claim 1, wherein:
the first distance measurement module is a distance measurement module based on a laser; and
the second distance measurement module is a distance measurement module based on a laser.

3. The measuring apparatus as set forth in claim 2, wherein:
either one of the first and second bodies is provided with a laser beam generator that is used for displaying a middle point and is rotated by a driving motor; and
the controller calculates an amount that the laser beam generator rotates to indicate the middle point between the points (A and B) by means of the direct distance (L1) to the point (A) measured by the first distance measurement module, the direct distance (L2) to the point (B) measured by the second distance measurement module, and the rotation angle detected by the rotation angle sensing means, and controls the driving motor according to the amount of rotation.
